(19) United States
(12) Patent Application Publication
(10) Pub. No.: US 2021/0222657 A1
(43) Pub. Date: Jul. 22, 2021

(54) VALVE FOR METERING A FLUID, IN PARTICULAR A FUEL INJECTOR

(71) Applicant: Robert Bosch GmbH, Stuttgart (DE)

(72) Inventors: Christian Suenkel, Altenkunstadt (DE); Frank Mueller, Ebensfeld (DE); Marcel Behringer, Rentweinsdorf (DE); Stefan Cerny, Bietigheim-Bissingen (DE); Andreas Glaser, Stuttgart (DE); Axel Heinstein, Wimsheim (DE); Martin Buehner, Backnang (DE); Matthias Boee, Ludwigsburg (DE)

(21) Appl. No.: 16/769,030

(22) PCT Filed: Nov. 23, 2018
(86) PCT No.: PCT/EP2018/082310

§ 371 Date: Jun. 2, 2020

(30) Foreign Application Priority Data
Jan. 11, 2018 (DE) 10 2018 200 357.2

(51) Int. Cl. F02M 51/06; F02M 61/18

(52) U.S. Cl. CPC F02M 51/0671; F02M 61/188; F02M 2200/9038; F02M 2200/8084; F02M 61/1873

(57) ABSTRACT

A fuel injector including an especially precisely aligned valve needle. The fuel injector includes an excitable actuator for actuating a valve closure element, which forms a sealing seat together with a valve seat surface formed on the valve seat body, and has injection orifices, which are developed downstream from the valve seat surface. The valve closure element is spherical and, as a part of a valve needle which is axially movable along a valve longitudinal axis, is fixedly connected to a pin-shaped solid valve needle shaft. A contact region of the valve needle shaft and the valve closure element is situated radially outside the valve longitudinal axis and surrounds it in the form of a ring. The fuel injector is particularly suitable for the direct injection of fuel into a combustion chamber of a mixture-compressing internal combustion engine having externally supplied ignition.

### FIELD

The present invention relates to a valve for metering a fluid, in particular a fuel injector.

### BACKGROUND INFORMATION

FIG. 1 shows a conventional valve in the form of a fuel injector. Such a valve is described in German Patent Application No. DE 10 2010 038437 A1, for example. The fuel injector is particularly suitable for the direct injection of fuel into a combustion chamber of internal combustion engines. The valve has an electromagnet as an excitable actuator for actuating a valve closure element, which forms a sealing seat together with a valve seat surface developed on a valve seat body; and it has at least one injection orifice, which is developed downstream from the valve seat surface. The valve closure element has a spherical design and, as a part of a valve needle which is axially movable along a valve longitudinal axis, is fixedly connected to a pin-shaped, solid valve needle shaft at its spherical pole.

### SUMMARY

An example valve for metering a fluid according to the present invention is distinguished by a simple and cost-effective production. According to an example embodiment of the present invention, a contact area of a pin-shaped solid valve needle shaft and a spherical valve closure element of a valve needle lies radially outside the valve longitudinal axis and surrounds it in the form of a ring. The spherical valve closure element no longer makes contact with the valve needle shaft by its spherical pole but at a contact circle which is situated radially farther outward. The spherical valve closure element is centered with respect to the valve needle shaft. In an advantageous manner, the rotation of the valve needle shaft during the welding process is transmittable by friction under a corresponding contact pressure. This leads to a better concentricity of the two welded components and has a positive effect on the function and wear behavior, especially between the valve closure element and the valve seat. Overall, less complex system engineering is able to be used for producing the fixed connection; in addition, a very stable welding process is ensured in which the weld spatter tendency is minimized, the crack susceptibility is reduced and an axial position sensitivity is remedied. The design variants according to the present invention make it possible to carry out the welding using a heat conduction welding seam, which offers the following advantages over a deep penetration welding seam:
a considerably lower weld spatter tendency,
less distortion, which leads to better concentricity of the valve closure element relative to the valve needle shaft in the welded state,
greater strength as a result of the larger joint cross-section, which avoids the risk of a seam collapse,
a lower crack tendency in the welded seam.

Advantageous further developments of and improvements in the valve of the present invention are possible by the measures described herein.

In accordance with an example embodiment of the present invention, it is particularly advantageous that the spherical valve closure element is provided with a coating on its lower side facing away from the valve needle shaft. Ideally, the coating is realized by an amorphous carbon layer such as DLC (diamond-like carbon).

### BRIEF DESCRIPTION OF THE DRAWINGS

Exemplary embodiments of the present invention are shown in simplified form in the figures and elucidated in greater detail below.

FIG. 1 shows a schematic section through a conventional fuel injector including a spherical valve closure element attached to a valve needle shaft of a valve needle.

FIG. 2 shows an enlarged schematic representation of a valve needle end as a cutaway view II-V from FIG. 1 according to the related art.

FIG. 3 shows a first exemplary embodiment of a valve needle according to the present invention in a cutaway view comparable to FIG. 2.

FIG. 4 shows a second exemplary embodiment of a valve needle according to the present invention in a cutaway view comparable to FIG. 2.

FIG. 5 shows a third exemplary embodiment of a valve needle according to the present invention in a cutaway view comparable to FIG. 2.

### DETAILED DESCRIPTION OF EXAMPLE EMBODIMENTS

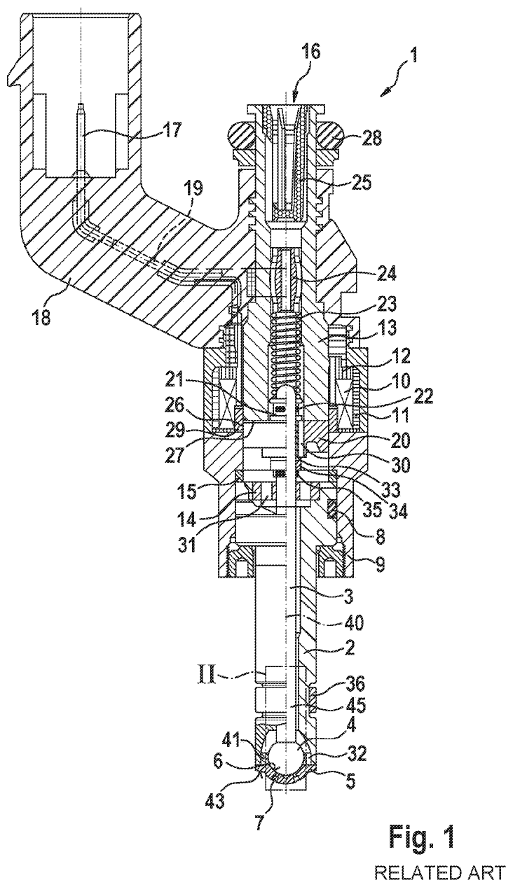

One example of a conventional fuel injector 1 is illustrated in FIG. 1 and is embodied in the form of a fuel injector 1 for fuel injection systems of mixture-compressing internal combustion engines having externally supplied ignition. Fuel injector 1 is particularly suitable for the direct injection of fuel into a combustion chamber (not shown) of an internal combustion engine. In general, the present invention is applicable to valves for metering a fluid.

Fuel injector 1 is made up of a nozzle body 2 in which a valve needle 3 is situated which is axially movable along a valve longitudinal axis 40. Valve needle 3 is in an operative connection with a spherical valve closure element 4, which cooperates with a valve seat surface 6 situated on a valve seat body 5 to form a sealing seat. Valve seat body 5 and nozzle body 2 may also be developed as one part. Fuel injector 1 in the exemplary embodiment is an inwardly opening fuel injector 1, which is provided with at least one injection orifice 7 but typically has at least two injection orifices 7. Ideally, however, fuel injector 1 is developed as a multi-orifice injector and thus has between four and thirty injection orifices 7. Nozzle body 2 is sealed from a valve housing 9 with the aid of a seal 8. Used as a drive, for instance, is an electromagnetic circuit which includes as an actuator a solenoid coil 10 which is encapsulated in a coil housing 11 and wound onto a coil brace 12 that rests against an internal pole 13 of solenoid coil 10. Internal pole 13 and valve housing 9 are separated from each other by a constriction 26 and connected to each other by a non-ferromagnetic connection component 29. Solenoid coil 10 is excited by an electric current which is able to be conducted through a line 19 via an electric plug contact 17. Plug contact 17 is surrounded by a plastic sheath 18, which may be extrusion-coated onto internal pole 13. Alternatively, piezoelectric or magnetostrictive actuators are able to be used as well.

Valve needle 3 is guided in a valve needle guide 14, which has a disk-shaped design, for example. A paired adjustment disk 15 is used for the lift adjustment. Situated on the other side of adjustment disk 15 is an armature 20. Via a first flange 21, it is connected in a friction-locked manner to valve needle 3, which is connected to first flange 21 by a welding seam 22. A restoring spring 23, which is pretensioned by an adjustment sleeve 24 in this particular design of fuel injector 1, is supported on first flange 21.

Fuel ducts 30, 31 and 32 extend in valve needle guide 14, in armature 20 and on a guide element 41. The fuel is supplied via a central fuel supply 16 and filtered with the aid of a filter element 25. Fuel injector 1 is sealed from a fuel distributor line (not shown in greater detail) by a seal 28 and from a cylinder head (not shown further) by a further seal 36.

An annular damping element 33, which is made of an elastomeric material, is situated on the downstream side of armature 20. It sits on a second flange 34, which is connected to valve needle 3 in a force-locking manner via a welding seam 35.

In the neutral state of fuel injector 1, restoring spring 23 acts upon armature 20 counter to its lift direction so that valve closure element 4 is retained in sealing contact on valve seat surface 6. When solenoid coil 10 is excited, it builds up a magnetic field, which moves armature 20 counter to the spring force of restoring spring 23 in the lift direction, with the lift being predefined by a working gap 27 situated between internal pole 13 and armature 20 in the neutral state. First flange 21, which is welded to valve needle 3, is likewise carried along by armature 20 in the lift direction. Valve closure element 4, which is connected to valve needle 3, lifts off from valve seat surface 6 and fuel is spray-discharged through injection orifices 7.

When the coil current is switched off, armature 20 falls away from internal pole 13 through the pressure of restoring spring 23 once the magnetic field has sufficiently decayed, so that first flange 21, which is connected to valve needle 3, is moved counter to the lift direction. This moves valve needle 3 in the same direction as well, with the result that valve closure element 4 sits down on valve seat surface 6 and thereby closes fuel injector 1.

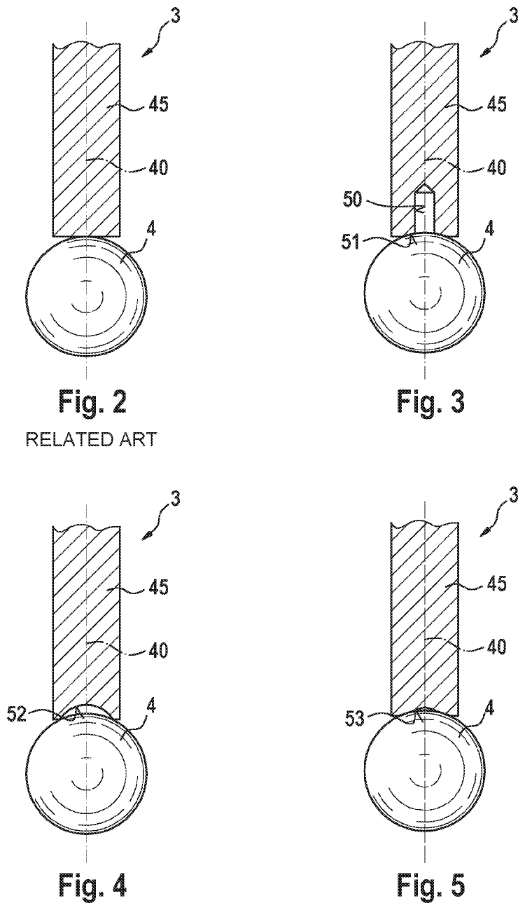

FIG. 2 shows an enlarged schematic representation of a valve needle end facing valve seat surface 6, in the form of a cutaway view II-V from FIG. 1 according to the related art. In the case of such a conventional valve needle 3, the pin-shaped solid valve needle shaft 45 is centrically positioned in the region of valve longitudinal axis 40 on spherical valve closure element 4. To produce the fixed connection between valve needle shaft 45 and valve closure element 4, valve closure element 4 is first pressed against the planar end face of valve needle shaft 45 while a circumferential deep welding seam or a plurality of welding points distributed across the circumference is subsequently produced around the central contact region with the aid of laser welding.

In order to achieve satisfactory concentricity characteristics of valve needle 3 and an exact alignment of valve needle shaft 45 and valve closure element 4 relative to each other, the production of the fixed connection between the two components is relatively time- and labor-intensive. This is so because either both components 4, 45 must be driven separately during the welding operation, which requires an exact adaptation of the rotational speeds of valve needle shaft 45 and valve closure element 4 in order to avoid cracks during the welding operation and subsequent cooling. Or, it is alternatively necessary to move the laser optics around the stationary components, i.e., valve needle shaft 45 and valve closure element 4, during the welding process, which results in a particularly high and costly outlay for the welding system.

Therefore, it is an object of the present invention to provide a valve needle 3 for a valve which is simpler in its production and has a secure and reliably stable connection region with the aid of a welding seam without a seam collapse and satisfies all specifications on the concentricity accuracy and the component alignment in the process.

According to an example embodiment of the present invention, the object may be achieved in that a contact region of pin-shaped solid valve needle shaft 45 and spherical valve closure element 4 lies radially outside valve longitudinal axis 40 and surrounds it in the form of a ring.

FIG. 3 shows a first exemplary embodiment of a valve needle 3 according to the present invention in a cutaway view which is comparable to FIG. 2. In this development, the lower end of valve needle shaft 45 facing valve closure element 4 has a blind bore 50 starting from the lower end face, which is used as a centering bore. Blind bore 50 terminates in a truncated cone region 51 in the direction of valve closure element 4, against which spherical valve closure element 4 is placed in order to improve the centering of the sphere. The contact of valve closure element 4 at valve needle shaft 45 thus is provided mainly in a linear and annular form at its truncated cone region 51.

FIG. 4 shows a second exemplary embodiment of a valve needle 3 according to the present invention in a cutaway view comparable to FIG. 2. In this development, the lower end of valve needle shaft 45 facing valve closure element 4 has a recess in the form of a spherical calotte region 52 starting from the lower end face, which is likewise used as a centering aid. To improve the centering of the sphere, spherical valve closure element 4 is placed against spherical calotte region 52. The diameter of spherical calotte region 52 is slightly smaller than the diameter of spherical valve closure element 4 in order to ensure that the contact of valve closure element 4 is always provided at the outer edge of spherical calotte region 52 of valve needle shaft 45.

FIG. 5 shows a third exemplary embodiment of a valve needle 3 according to the present invention in a cutaway view comparable to FIG. 2. In this development, lower end of valve needle shaft 45 facing valve closure element 4 has a conical region 53 starting from the lower end face, which is used for centering valve closure element 4. Spherical valve closure element 4 is placed against conical region 53 in order to improve the centering of the sphere. The contact of valve closure element 4 at valve needle shaft 45 thus is provided largely in a linear or ring-shaped form at its conical region 53.

In all exemplary embodiments, spherical valve closure element 4 may be provided with a coating such as a DLC coating (diamond-like carbon) on its lower side facing away from valve needle shaft 45.

The illustration of the connection regions of valve needle 3 in FIGS. 3 through 5 is merely schematic and not exactly true to scale.

1-10. (canceled)

11. A fuel injector for a direct injection of fuel into a combustion chamber, for a fuel injection system of an internal combustion engine, comprising:
an excitable actuator configured to actuate a valve closure element, the valve closure element forming a sealing seat together with a valve seat surface formed on a valve seat body;
at least one injection orifice downstream from the valve seat surface;
wherein the valve closure element is spherical and is part of a valve needle which is axially movable along a valve longitudinal axis, the valve closure member being fixedly connected to a pin-shaped solid valve needle shaft, a contact region of the valve needle shaft and the valve closure element lies radially outside the valve longitudinal axis and surrounds it in the form of a ring.

12. The fuel injector as recited in claim 11, wherein the valve closure member has a largely linear contact at the valve needle shaft, the valve closure element being able to be placed against the valve needle shaft and fixed in place in a centered manner.

13. The fuel injector as recited in claim 11, wherein a lower end face of the valve needle shaft facing the valve closure element has a conical region against which the valve closure element is placed.

14. The fuel injector as recited in claim 11, wherein a lower end face of the valve needle shaft facing the valve closure element has a blind bore which is used as a centering bore.

15. The fuel injector as recited in claim 14, wherein the blind bore terminates in a truncated cone region in a direction of the valve closure element against which the spherical valve closure element is placed.

16. The fuel injector as recited in claim 11, wherein a lower end face of the valve needle shaft facing the valve closure element has a recess in the form of a spherical calotte region against which the valve closure element is placed.

17. The fuel injector as recited in claim 16, wherein a diameter of the spherical calotte region is slightly smaller than a diameter of the spherical valve closure element.

18. The fuel injector as recited in claim 11, wherein the spherical valve closure element has a coating on a lower side facing away from the valve needle shaft.

19. The fuel injector as recited in claim 18, wherein the coating is an amorphous carbon layer.

20. The fuel injector as recited in claim 19, wherein the amorphous carbon layer is diamond-like carbon.

21. The fuel injector as recited in claim 11, wherein the fixed connection of the valve needle shaft and the valve closure element is produced by welding through an application of a heat conduction welding seam.
